(19) United States
(12) Patent Application Publication
(10) Pub. No.: US 2006/0026510 A1
(43) Pub. Date: Feb. 2, 2006

(54) Method for optimizing markup language transformations using a fragment data cache

(75) Inventors: Scott A. Boag, Woburn, MA (US); Gennaro A. Cuomo, Cary, NC (US); Harvey W. Gunther, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/903,146

(22) Filed: Jul. 30, 2004

(51) Int. Cl. G06F 17/21

(52) U.S. Cl. 715/522; 715/513

(57) ABSTRACT

A method, computer program product, and a data processing system for transforming markup language documents is provided. A first markup language document in a first format to be transformed into a second document of a second format is obtained. A reference to a source of a data fragment to be inserted into the second document is identified. A data fragment cache is interrogated. A determination of whether the data fragment is located in the data fragment cache is made. The first markup language document is transformed into the second document. The second document includes the data fragment.

### BACKGROUND OF THE INVENTION

1. Technical Field

The present invention relates generally to an improved data processing system and in particular to a data processing system and method for caching markup language content. Still more particularly, the present invention provides a mechanism for an extensible markup language fragment cache.

2. Description of Related Art

The Extensible Stylesheet Language Transformations (XSLT) is a standard for transforming XML documents into other XML documents or documents of other formats. The use of XSLT is becoming more prevalent but requires significant overhead that is frequently prohibitive. In a typical application server/XSLT interaction, a servlet will generate an XML document that will subsequently be transformed to HTML for end user presentation.

In conventional XSLT usage, the servlet builds the complete XML representation of the end user response. In some cases, the contained information is completely dynamic in that it is unique to the particular request. However, in other cases, the page may contain a mixture of dynamic content and relatively static content. In such cases, the conversion of the static content from XML to HTML is wasteful. For example, the static information has to be retrieved for each request and assembled by the application. Additionally, the XSL transform processor has to process this data in the form of XML.

Thus, it would be advantageous to provide a system and method for transforming a markup language document in a manner that reduces the retrieval and processing of static information. It would be further advantageous to provide a system and method that facilitates an XSLT transformation of XML by reducing the number of retrievals and transformations of static information.

### BRIEF SUMMARY OF THE INVENTION

The present invention provides a method, computer program product, and a data processing system for transforming markup language documents. A first markup language document in a first format to be transformed into a second document of a second format is obtained. A reference to a source of a data fragment to be inserted into the second document is identified. A data fragment cache is interrogated. A determination of whether the data fragment is located in the data fragment cache is made. The first markup language document is transformed into the second document. The second document includes the data fragment.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system that may be implemented as a client in accordance with a preferred embodiment of the present invention;

FIG. 4 is a diagram illustrating interaction of components in the present invention in accordance with a preferred embodiment of the present invention;

FIG. 5 is an exemplary markup language fragment cache implemented according to a preferred embodiment of the present invention; and

FIG. 6 is a flowchart of processing performed by a markup language fragment cache routine implemented according to a preferred embodiment of the present invention.

### DETAILED DESCRIPTION OF THE INVENTION

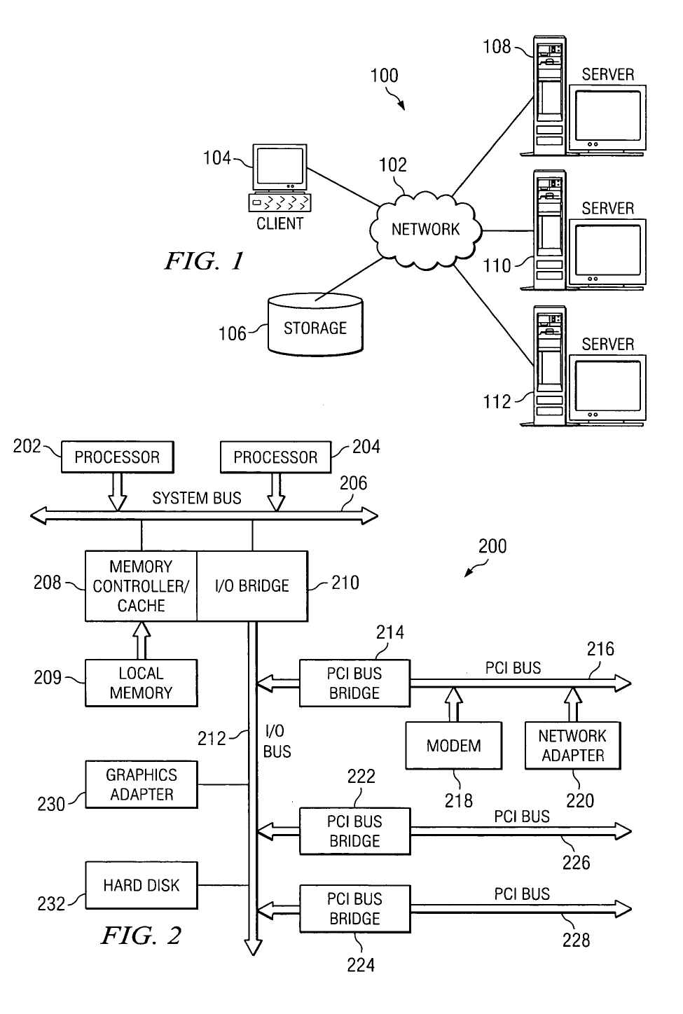

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 108-112 are connected to network 102 along with storage unit 106. In addition, client 104 is connected to network 102. Client 104 may be, for example, a personal computer or network computer. In the depicted example, servers 108-112 provide data, such as boot files, operating system images, applications, or web pages to client 104. Client 104 is a client to one or more of servers 108-112. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 108 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

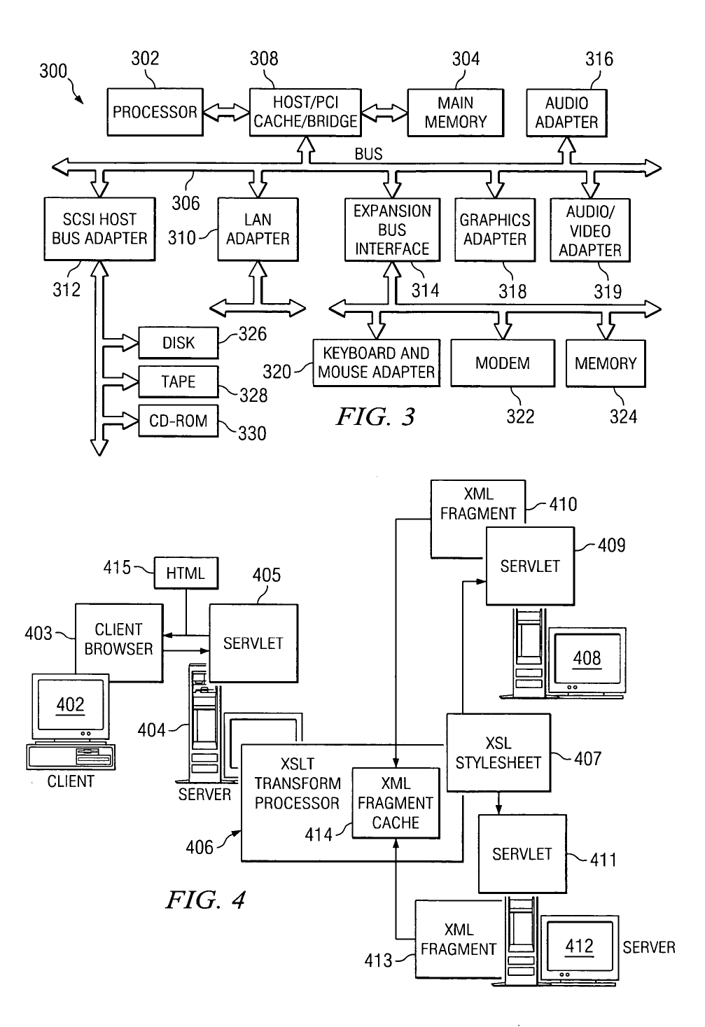

With reference now to FIG. 3, a block diagram illustrating a data processing system is depicted in which the present invention may be implemented. Data processing system 300 is an example of a client computer such as client 104 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning now to FIG. 4, a diagram illustrating interaction of components in the present invention is depicted in accordance with a preferred embodiment of the present invention. As shown in FIG. 4, in this illustrative example, client browser 403 is executing on client 402, which may be implemented as data processing system 300 in FIG. 3. When client browser 403 sends a request for a Web page to servlet 405, which is executing on server 404, servlet 405 invokes XSLT transformation processor 406 to produce a formatted HTML file. Server 404 may be implemented as data processing system 200 shown in FIG. 2. Often the resulting HTML file includes both dynamic and static content.

In order to produce the formatted HTML file, XSLT transformation processor 406 incorporates XSL stylesheet 407 to transform a root document with no content into an HTML document that includes dynamic content. Using the mechanism of the present invention, the sources of the dynamic content may be specified in XSL stylesheet 407 using a document expression. In this example, XSL stylesheet 407 includes two sources: one source from servlet 409, which is executing on server 408, and another source servlet 411, which is executing on server 412.

When the document expression is evaluated by XSL transformation processor 406, XSL transformation processor 406 requests the dynamic content from servlet 409 and 411 in a form of XML fragments. Responsive to receiving the request, servlet 409 and 411 generate XML fragments 410 and 413 respectively and return XML fragments 410 and 413 to XSL transformation processor 406. XSL transformation processor 406 then places XML fragments 410 and 413, which include the dynamic content, in XML fragment cache 414 for future use. XML fragment cache 414 may be stored on storage unit 106 shown in FIG. 1 that is network-accessible, or may alternatively be stored locally, for example on hard disk 232 of server 404 in accordance with a preferred embodiment of the present invention. Once the dynamic content is obtained, XSL transformation processor 406 completes the transformation by generating an output HTML document using XML fragments 410 and 413. Finally, servlet 405 returns the resulting HTML file 415 to client browser 403.

Subsequently, client browser 403 sends a similar request to servlet 405 for a Web page, which requires the same dynamic content. Instead of immediately requesting the dynamic content from servlet 409 and 411, XSL transformation processor 406 examines the specified dynamic content in XSL stylesheet 407 and determines if XML fragments 410 and 413 already exist in XML fragment cache 414.

If XML fragments 410 and 413 already exist in XML fragment cache 414, XSL transformation processor 406 then retrieves cached XML fragments 410 and 413 from XML fragment cache 414 and generates the resulting HTML file. Otherwise, XSL transformation processor 406 invokes servlet 409 and 411 to generate the dynamic content required.

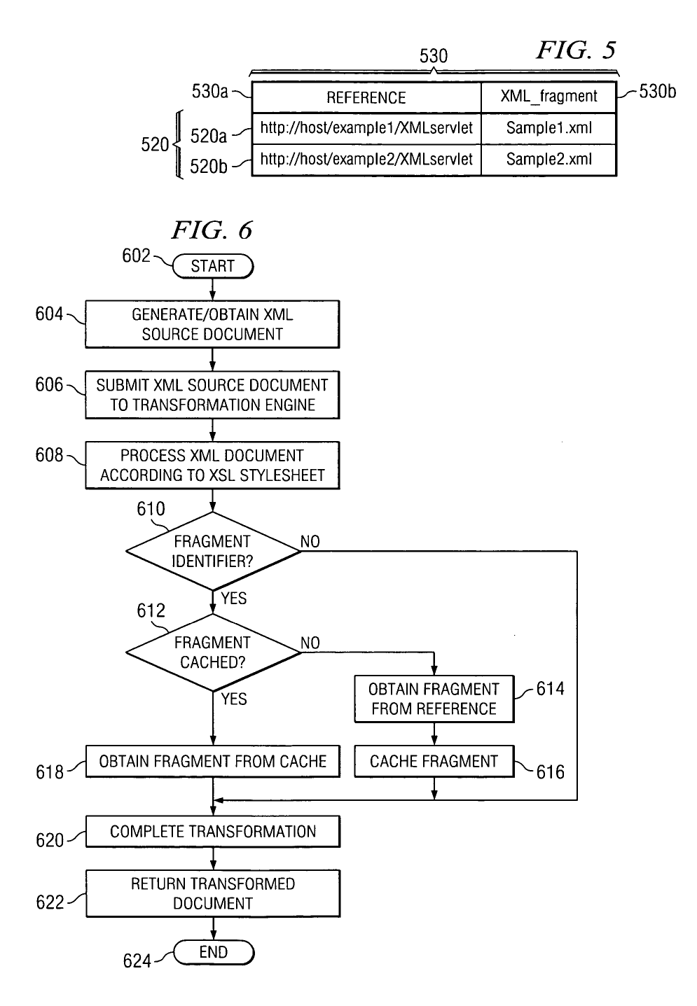

FIG. 5 is an exemplary XML fragment cache implemented according to a preferred embodiment of the present invention. Table 500 comprises a plurality of records 520 and fields 530. Table 500 may be stored on hard disk 232, fetched therefrom by processor 202 or 204, and processed by data processing system 200 shown in FIG. 2. Alternatively, table 500 may be stored on a network-accessible storage device or another suitable mechanism.

Each record 520a-520b, or row, comprises data elements in respective fields 530a-530b. Fields 530a-530b have a respective label, or identifier, that facilitates insertion, deletion, querying, or other data operations or manipulations of table 500. In the illustrative example, fields 530a-530b have respective labels of “Reference” and “XML_fragment”. In the illustrative example, field 530a is the key field and values of key field 530a specify the address of an XML source, such as XML servlet 409 or 411, that produces XML code to be inserted into an XML document.

In the illustrative example, data elements of key field 530a comprise uniform resource locators (URLs) that reference an XML fragment source. Other fragment identifiers may be suitably substituted for fragment URLs. Field 530b contains XML code generated or otherwise obtained from the reference in a corresponding record. For example, field 530b of record 520a contains an XML fragment in a file Sample1.xml that is generated from an XML servlet at the URL http://host/example1/XMLServlet. Likewise, field 530b of record 520b contains an XML fragment in a file Sample2.xml that is generated from an XML servlet at the URL http://host/eample2/XMLServlet.

FIG. 6 is a flowchart of processing performed by the markup language fragment cache routine implemented according to a preferred embodiment of the present invention. The routine begins (step 602), and an XML source document is generated or otherwise obtained (step 604). The XML source document is then submitted to a transformation processor (step 608), and is processed according to one or more XSL stylesheets (step 608). The transformation processor then evaluates the stylesheet for a fragment identifier (step 610), such as an include statement. For example, an include statement within an XSL stylesheet that provides a reference to an XML fragment source may be formatted as follows:
<xsl:value-of select=“document(http://host/data/servlet)>

In the event that no fragment identifier is located, the transformation process completes the document transformation (step 620) in a conventional fashion.

If a fragment identifier is located within the XSL stylesheet at step 610, the transformation processor preferably interrogates a fragment cache to determine if the fragment has been previously cached (step 612). In the event that the fragment has not been previously cached, the transformation processor then obtains the fragment by invoking the servlet or other fragment source referenced by the fragment identifier (step 614). Subsequently, the transformation processor caches the obtained fragment (step 616), and then completes the transformation process according to step 620.

Returning again to step 612, if the transformation processor determines the fragment is cached, the fragment is retrieved from the cache (step 618), and the document transformation is completed according to step 620. The transformed document is then returned, and the transformation routine cycle then ends (step 624).

Thus, a system and method for transforming a markup language document in a manner that reduces the retrieval and processing of relatively static information is provided. XML fragments are cached during an XSLT transformation when the XML fragment has not been previously generated. Advantageously, subsequent document transformations that require the cached XML fragment do not result in invocation of the XML fragment source but instead retrieve the XML fragment from the fragment cache.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of transforming markup language documents, the method comprising the computer implemented steps of:
obtaining a first markup language document in a first format to be transformed into a second document of a second format;
identifying a source of a data fragment to be inserted into the second document;
interrogating a data fragment cache;
determining if the data fragment is located in the data fragment cache; and
transforming the first markup language document into the second document, wherein the second document includes the data fragment.

2. The method of claim 1, wherein the step of obtaining further includes:
generating the first markup language document by an extensible markup language servlet.

3. The method of claim 1, wherein identifying a source further includes:
identifying an include statement that references a servlet adapted to generate the data fragment, wherein the include statement is in a stylesheet.

4. The method of claim 1, wherein the step of determining comprises determining that the data fragment is not located in the data fragment cache, wherein the method further includes:
invoking the source; and
receiving the data fragment from the source.

5. The method of claim 4, further comprising:
responsive to receiving the data fragment, storing the data fragment in the data fragment cache.

6. The method of claim 1, wherein the step of determining comprises determining that the data fragment is located in the data fragment cache, wherein the method further includes:
receiving the data fragment from the data fragment cache.

7. The method of claim 1, wherein the first format is an extensible markup language format.

8. A computer program product in a computer readable medium for transforming markup language documents, the computer program product comprising:
first instructions that obtain a first markup language document in a first format;
second instructions that identify a source of a data fragment that is to be inserted into a second document, wherein the second document is a transform of the first markup language document;
third instructions that interrogate a data fragment cache; and
fourth instructions, responsive to the interrogation of the data fragment cache, that transform the first markup language document into the second document, wherein the second document includes the data fragment.

9. The computer program product of claim 8, wherein the first instructions comprise an extensible markup language servlet.

10. The computer program product of claim 8, wherein the second instructions comprise an Extensible Stylesheet Language transform processor.

11. The computer program product of claim 8, further comprising:
fifth instructions that, responsive to the third instructions determining that the data fragment is not located in the data fragment cache, invoke the reference source; and
sixth instructions that receive the data fragment from the source.

12. The computer program product of claim 11, further comprising:
seventh instructions that store the data fragment in the data fragment cache.

13. The computer program product of claim 8, further comprising:
fifth instructions that, responsive to the third instructions determining that the data fragment is located in the data fragment cache, retrieve the data fragment from the data fragment cache.

14. The computer program product of claim 8, wherein the first document is an extensible markup language formatted document.

15. A data processing system for transforming markup language documents, comprising:
a memory that contains a transformation processor as a set of instructions; and
a processing unit, responsive to execution of the set of instructions, that transforms a first document in a markup language format into a second document, wherein the processing unit inserts a data fragment into the second document responsive to interrogation of a data fragment cache.

16. The data processing system of claim 15, wherein the processor invokes a source responsive to determining that the data fragment is not stored in the data fragment cache.

17. The data processing system of claim 15, wherein the processor obtains the data fragment from the data fragment cache.

18. The data processing system of claim 17, wherein the processor stores the data fragment in the data fragment cache.

19. The data processing system of claim 15, wherein the first document in an extensible markup language formatted document.

20. The data processing system of claim 15, wherein the transformation processor transforms the first document into the second document according to a stylesheet that includes an identifier of a source of the data fragment.
